(19) United States
(12) Patent Application Publication
(10) Pub. No.: US 2019/0329691 A1
(43) Pub. Date: Oct. 31, 2019

(54) AUTONOMOUS FOOD PRODUCT DELIVERY VEHICLE SYSTEM AND METHOD

(71) Applicant: PepsiCo, Inc., Purchase, NY (US)

(72) Inventors: Robert Crawford, Yorktown Heights, NY (US); Yong Jin Serock, Newtown, CT (US)

(21) Appl. No.: 15/962,874

(22) Filed: Apr. 25, 2018

(51) Int. Cl. B60P 3/025; B60P 3/06; G05D 1/00; G05D 1/02; B60P 3/20; G06Q 10/08

(52) U.S. Cl. CPC B60P 3/0257; B60P 3/06; G06Q 10/08355; G05D 1/0291; B60P 3/20; G05D 1/0088

(57) ABSTRACT

A system and method for delivering food products using an autonomous distribution vehicle is disclosed. The system includes a first distribution vehicle that is configured to carry food products and at least one autonomous distribution vehicle. While the first distribution vehicle delivers food products, the autonomous distribution vehicle may depart the first distribution vehicle and deliver its own set of food products. The autonomous distribution vehicle can then return to the first distribution vehicle.

### FIELD

The described embodiments generally relate to systems and methods for delivering food products to customers using a large delivery vehicle and a fleet of smaller, autonomous delivery vehicles.

### BACKGROUND

Frequent delivery of food products to customers is necessary to ensure sufficient supply of food products at both the wholesale and retail level. Currently, a variety of vehicles, such as cargo vans and delivery trucks, are used to deliver food products in urban and rural environments. These vehicles and their methods of use can be inefficient, especially in urban areas with a range of customers of different sizes.

### BRIEF SUMMARY

A system is disclosed for delivering food products to customers using a plurality of vehicles includes a plurality of autonomous distribution vehicles and a non-autonomous distribution vehicle that includes a first cargo compartment configured to hold at least one set of food products and a second cargo compartment configured to store a plurality of autonomous distribution vehicles. The non-autonomous distribution vehicle also includes a first set of food products associated with a first volume customer contained in the first cargo compartment.

Each of the autonomous distribution vehicles includes a remote navigation sensor and a small cargo compartment configured to hold at least one of a second set of food products. Each of the plurality of autonomous distribution vehicles is configured to deliver the second set of food products autonomously to a location of the second volume customer while the non-autonomous distribution vehicle is delivering the first set of food products to the first volume customer. The autonomous distribution vehicles are configured to autonomously return to the non-autonomous distribution vehicle after delivering the second set of food products.

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 is a side view of an autonomous food product delivery vehicle system according to an embodiment.

FIG. 2 is a side view of another embodiment of an autonomous food product delivery vehicle system.

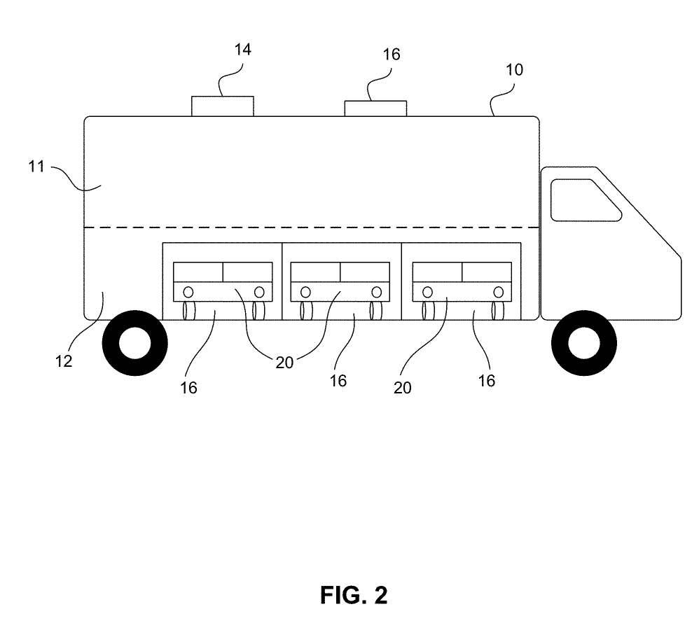

FIG. 3 is a top view of a partial cross-section of a docking bay on a first distribution vehicle according to an embodiment.

FIG. 4 is a side view of an autonomous delivery vehicle according to an embodiment.

FIG. 5 is a top view of an autonomous delivery vehicle according to an embodiment.

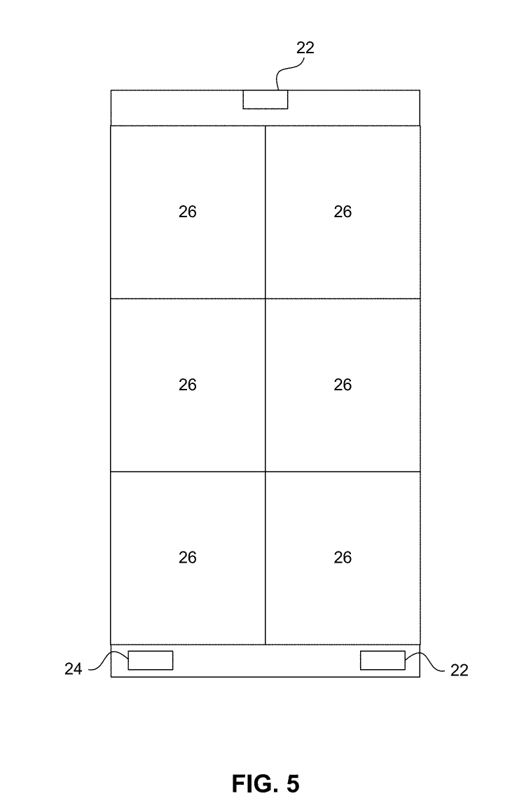

FIG. 6 is a block diagram of the autonomous delivery system in use according to an embodiment.

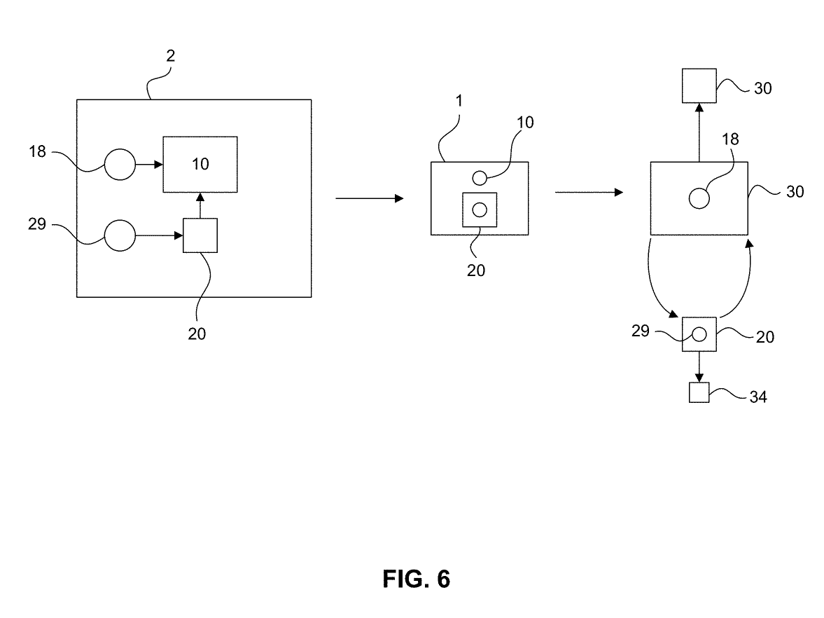

FIG. 7 is a map view of the autonomous delivery system in use according to an embodiment.

FIG. 8 is a block diagram showing the steps of a method of using the delivery system according to an embodiment.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The delivery of food products, for example beverages including water, soda, and juice and foods including candy, potato chips, and trail mix, to customers is an important consideration in food product sales. This disclosure will focus on delivery of food products from a large, central origin to a group of customers. The customer may be a large volume customer, referred to as a first volume customer 30 below. An example of a delivery for first volume customer 30 may be several cargo pallets of food product, each pallet including multiple cases of beverages and many boxes of food. Such a delivery to first volume customer 30 may go to a first volume customer location 32, such as a warehouse, from which first volume customer 30 might supply various retail locations, such as stores or vending machines, or may be a high volume individual retail store.

Another type of customer is a small volume customer, referred to as a second volume customer 34 below. A delivery for a second volume customer 34 might consist of a few cases of beverages and a few boxes of food, but it might be as small as a single box of food or single case of beverages. Examples of second volume customers 34 might be individual retail stores or vending machine locations. In a typical urban environment there are fewer of the larger first volume customers 30 and many of the smaller second volume customers 34 that need to receive deliveries of food products.

The existence of these different customer sizes can create an efficiency problem when delivering food products, especially in the urban environment. A typical urban environment, such as a city or suburb, is serviced by delivery vehicles ranging from cargo vans to tractor-trailer trucks or “semi” trucks. The efficiency problem stems from the fact that it is much more time efficient to serve a single, or a limited number of, large customers because the delivery vehicle only needs to drive from a central loading location, typically a large warehouse outside of the urban area, to the large customer's location and unload the food product. Delivering food products to many smaller customers requires the additional time to travel to each smaller customer and deliver the food product. Packing the food products for smaller customers into the delivery vehicle requires more time spent planning in advance, and optimizing the time spent visiting multiple small customers is a non-trivial problem given the difficulty of calculating travel and unloading time in an urban environment.

These problems are magnified when a delivery includes one or two large customers combined with several small customers. The same travel time problem occurs, and now packaging is even more complicated, as there are several small deliveries mixed in with the larger deliveries. It is easier to accidentally include a single case of beverages in a much larger delivery than it is to accidentally add a case of beverages to a delivery consisting of only a few cases of beverages and food boxes, for example.

In one embodiment, a delivery system 1 for delivering food products to customers includes one or more autonomous vehicles 20. Delivery system 1 includes a first distribution vehicle 10 that includes a first cargo compartment 11 configured to hold at least one set of food products, a second cargo compartment 12 configured to store one or more autonomous distribution vehicles 20, and a first set of food products 19 associated with first volume customer 30 stored in first cargo compartment 11.

In some embodiments, the autonomous distribution vehicles 20 includes a remote navigation sensor 22 that is configured to gather information about the location of autonomous distribution vehicle 20 and its surrounding environment. Remote navigation sensor 22 might include several different sensors, such as, for examples, a Global Positioning System (“GPS”) sensor, a camera, or an ultrasonic sensor. Some embodiments of autonomous distribution vehicle may also include a controller 24, which may perform various tasks that include controlling the movement of autonomous vehicle and interacting with first distribution vehicle 10 and customers.

Some embodiments of autonomous distribution vehicle 20 also include one or more of small cargo compartment 26 that are configured to hold at least one set of food products. Small cargo compartment 26 may be accessible from the exterior of autonomous distribution vehicle 20 and also may include a small cargo compartment lock 27 that allows small cargo compartment 26 to be secured.

Autonomous distribution vehicles 20 may be stored in first distribution vehicle 10 in a releasable manner. Autonomous distribution vehicles 20 may be released from first distribution vehicle 10 at an appropriate time and location. A second set of food products 29 for second volume customer 34 is stored in small cargo compartment 26, wherein the volume of second set of food products 29 may be less than the volume of first set of food products 19.

Autonomous distribution vehicle 20 is configured to deliver a set of food products 29 autonomously to a second volume customer location 36 while first distribution vehicle 10 is delivering first set of food products 19 to first volume customer 30. Autonomous delivery vehicle 20 is configured to autonomously return to first distribution vehicle 10 after delivering second set of food products 29.

In some embodiments, the delivery of food products may be simplified by allowing first delivery vehicle 10 to proceed directly to first volume customer 30, deliver first set of food product 19 there, and return to a starting location 2. While the delivery to first volume customer 30 is underway, one or more autonomous delivery vehicles 20 loaded into first delivery vehicle 10 can depart first delivery vehicle 10 and deliver second set of food products 29 to any second volume customers 34. Autonomous delivery vehicles 20 then return back to first delivery vehicle 10, preferably before the delivery of first set of food product 19 is completed. Even if the delivery to first volume customer 30 is complete before autonomous delivery vehicles 20 have all returned, time is still saved because the deliveries to second volume customer 34 have already begun. In addition, time spent planning the packaging of first distribution vehicle 10 is saved. Finally, manpower is saved because in this embodiment only first distribution vehicle 10 must have a driver, whereas autonomous distribution vehicles 20 do not requires human control.

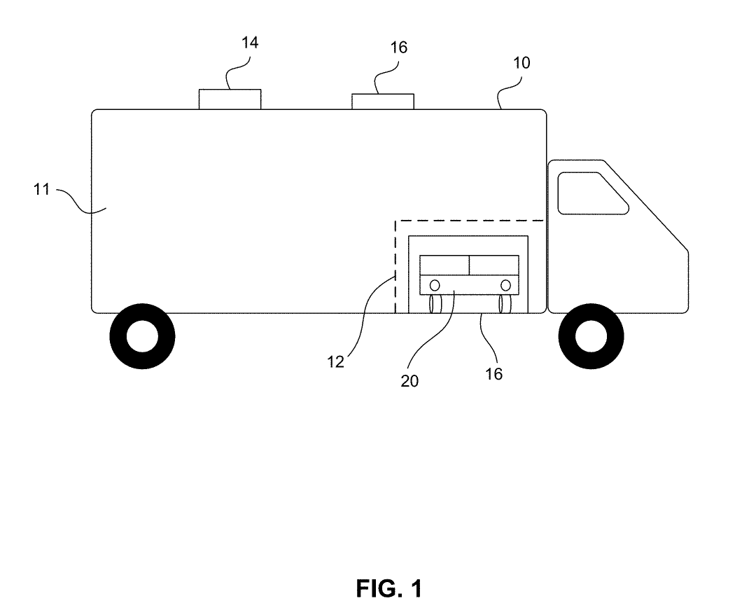

In some embodiments, first distribution vehicle 10 may be a modified version of a standard medium-sized delivery truck which is well known in the art of food product delivery. Such vehicles typically weigh between 14,000 to 26,000 pounds gross vehicle weight. Modifying an existing street-legal delivery truck is advantageous because it reduces costs, but a custom-built vehicle may also be designed as first delivery vehicle 10. Such a custom design might include other features adapted to the specific delivery environment in question, such as tracked propulsion for rough-surface environments. An embodiment of first distribution vehicle 10 is illustrated in FIG. 1. As can be seen, first distribution vehicle 10 incorporates the general features of an ordinary delivery truck and is adapted to deliver packages. Only the specific modifications needed for purposes of this disclosure will be discussed here; the general design and features of a delivery truck are well known in the art and will not be recited.

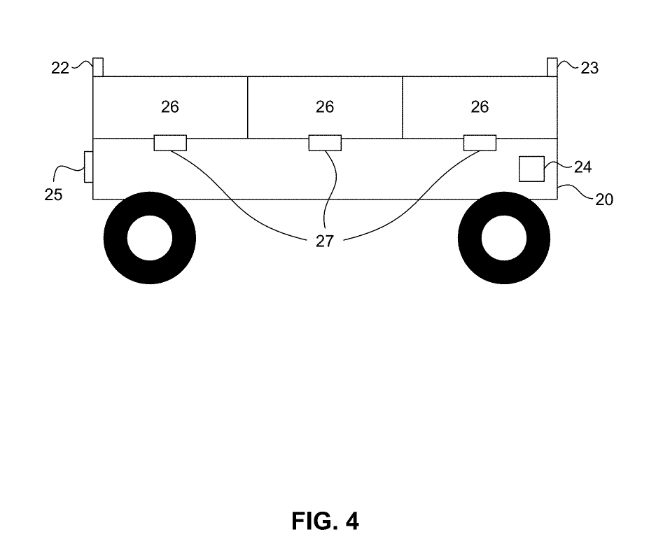

A side view of first delivery vehicle 20 is shown with the outline of first cargo compartment 11 and second cargo compartment 12 shown in dashed lines in the rear section of first distribution vehicle 10. An example of autonomous distribution vehicle 20 can be seen loaded into a docking bay 16 in second cargo compartment 12. In this embodiment, first cargo compartment 11 may be “L” shaped, extending over the top of smaller second cargo compartment 12. This allows for maximum cargo storage for any customers that are being served by first distribution vehicle 10 directly, but has the effect of reducing the number of autonomous distribution vehicles 20 that may be carried by first distribution vehicle 10. In another embodiment of first distribution vehicle 10, as shown in FIG. 4, first cargo compartment 11 and second cargo compartment 12 extend the full length of the rear section of first distribution vehicle 10, with first cargo compartment 11 located above second cargo compartment 12. This configuration trades cargo capacity in first cargo compartment 11 for additional capacity in second cargo compartment 12, which allows for more autonomous delivery vehicles 20 to be stored in second cargo compartment 12.

Some embodiments of first distribution vehicle 10 include a central navigation sensor 13 and a central transceiver 14. Central navigation sensor 13 is used to determine the location of first distribution vehicle 10. For example, central navigation sensor 13 might include a Global Positioning System (“GPS”) sensor or other appropriate way to determine location. Central transceiver 14 includes a transmitter and receiver that is configured to communicate data with other transceivers. For example, central transceiver 14 might be capable of communicating with a remote transceiver 23 that is located on autonomous distribution vehicle 20. In another example, central transceiver 14 might be capable of communicating with other transceivers, such as a transceiver located at starting location 2. Central transceiver 14 may be configured to operate on a variety of frequencies such as Very High Frequency or Ultra High Frequency ranges. Furthermore, central transceiver 14 might be compatible with specific network standards such as cell phone data networks, WIFI™, or BLUETOOTH® for sending and receiving data. Central transceiver 14 might combine more than one of these capabilities to send and receive data. In a preferred embodiment, central transceiver 14 will be capable of long range data communication, on the order of a mile or more in an urban environment, with multiple other transceivers. This embodiment of central transceiver 14 will be capable of sending out a data stream containing an updated location determined by central navigation sensor 13 at least once every 10 minutes and more preferably more than once every minute.

As discussed above, first distribution vehicle 10 can contain one or more of autonomous distribution vehicle 20. Autonomous distribution vehicle 20 is stored in first distribution vehicle 10 in a secure manner which will prevent any shifting or movement of autonomous distribution vehicle 20 during normal driving maneuvers of first distribution vehicle 10. The storage of autonomous distribution vehicle 20 is also configured to facilitate the easy loading and unloading of autonomous distribution vehicle 20 and minimize the required space for storage in first distribution vehicle 10.

In an embodiment, the storage system includes docking bay 16 located in second cargo compartment 12 of first distribution vehicle 10. As shown, for example, in FIG. 1, docking bay 16 is a rectangular opening in the rear section of first distribution vehicle 10. The opening is sized to fit autonomous vehicle 20.

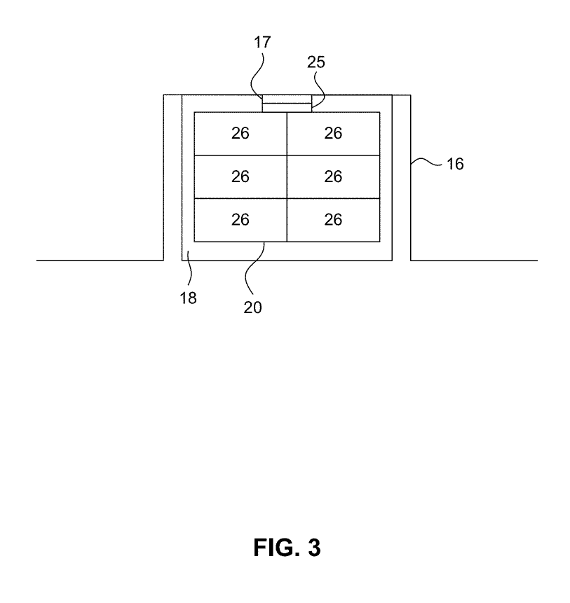

Docking bay 16 is sized to store autonomous distribution vehicle 20. A top view of docking bay 16 is shown in FIG. 3, which is a partial section view taken at approximately halfway between the ground and the top of first distribution vehicle 10. Here, the top of autonomous vehicle 20 is visible, shown in this embodiment with a set of six small cargo compartments 26 taking up most of the top surface. Visible in FIG. 3 is a docking bay loader 18, which may be a ramp hinged near the rear of docking bay 16, located towards the top of FIG. 3. In this “ramp” embodiment docking bay loader 18 may unlock and be lowered to the ground and autonomous vehicle 20 can drive up onto docking bay loader 18. Appropriate tie-downs or wheel locks can be provided on docking bay loader 18 to secure autonomous vehicle 20. Docking bay loader 18 can then be lifted up and secured into the stored position in first distribution vehicle 10.

In some embodiments, docking bay loader 18 might be an elevator-like platform that lowers down to the ground. Autonomous vehicle 20 can drive straight onto docking bay loader 18 and be secured with the appropriate tie-down or wheel locks. Docking bay loader 18 can then rise up into the stored position in first distribution vehicle. Other possible variants of docking bay loader 18 might include a single cable that lowers from docking bay 16 and attaches to an appropriate fitting on the top of autonomous vehicle 20. The cable might then be reeled in and autonomous vehicle 20 positioned into docking bay 16 without need for a “floor” for autonomous vehicle 20 to rest on. In this embodiment of docking bay loader 18 additional tie-downs or straps might deploy from the side and rear walls of docking bay 16 in order to secure autonomous vehicle 20.

In some embodiments, docking bay 16 may include a docking bay interface 17, as shown, for example, in FIG. 3. Docking bay interface 17 is configured to provide a physical connection with autonomous vehicle 20 that is capable of transferring data, including current location and updated instructions, and electrical power between first distribution vehicle 10 and autonomous vehicle 20. In the embodiment shown in FIG. 3, docking bay interface 17 is located at the rear of docking bay 16 and is configured to mate with a docking interface 25 located on the rear of autonomous vehicle 20. This embodiment is designed for a “ramp type” docking bay loader 18 where autonomous vehicle 20 drives up the ramp and then mates docking interface 25 with docking bay interface 17 by driving into the rear of docking bay 16. Other embodiments of docking bay interface 17 might include similar connectors on the side or top walls of docking bay 16, or even an embodiment that is incorporated into the cable of the “cable type” docking bay loader 18 described above.

Autonomous distribution vehicle 20 is a vehicle that may be configured to operate autonomously, which is to say without a human in control. As seen in FIG. 1, autonomous distribution vehicle 20 is significantly smaller than first distribution vehicle 10 and is configured to be loaded into first distribution vehicle 10. After first distribution vehicle 10 stops to unload first set of food products 19, autonomous distribution vehicle 20 is unloaded by docking bay loader 18 and proceeds, without human intervention, to second volume customer location 36. Autonomous distribution vehicle 20 then unloads second set of food products 29 and returns to first distribution vehicle 10 and is loaded by docking bay loader 18 without human intervention. Some embodiments of autonomous distribution vehicle 20 can be controlled by a remotely located human if desired. Such control can occur via transmissions through remote transceiver 23. Human control of autonomous distribution vehicle 20 might be desirable for testing or troubleshooting purposes.

Autonomous distribution vehicle 20 may be configured to operate in an urban environment on surfaces such as roads and sidewalks. Embodiments of autonomous distribution vehicle 20 might include various propulsion elements, such as wheels, tracks or hovercraft-type propulsion. In some embodiments, autonomous distribution vehicle 20 may be capable of flight. Flight capability may allow autonomous distribution vehicle to take a more direct path between destinations, which reduces the time required for delivery. Autonomous distribution vehicle 20 might be powered by electrical power stored in a battery, an internal combustion engine, or a hybrid design including both a battery and an engine. Elements related to the propulsion, power source, and general chassis design of small vehicles such as autonomous distribution vehicle 20 are well known in the art and will not be recited here.

A side view of an embodiment of autonomous distribution vehicle 20 is shown in FIG. 4. This embodiment is roughly rectangular in shape and includes four wheels as a propulsion mechanism. An embodiment of remote navigation sensor 22 is visible on the top surface of autonomous distribution vehicle 20. Remote navigation sensor 22 is configured to provide controller 24 with the information necessary to navigate autonomous distribution vehicle 20. This information may include location information and information about the immediate environment, such as positions of obstacles, other vehicles, buildings, and pedestrians. Other information that might be provided by remote navigation sensor 22 might include street sign information.

Embodiments of remote navigation sensor 22 might include a series of different sensors. For example, an embodiment of remote navigation sensor 22 might include a GPS sensor to provide location data, a series of video cameras to provide 360° video coverage, ultrasonic or electromagnetic obstacle sensors at the front and rear of autonomous distribution vehicle 20, and impact-sensitive front and rear bumpers. Other embodiments of remote navigation sensor 22 might not include all of the sensors listed here. In addition other types of sensors might be added to embodiments of remote navigation sensor 22 as necessary to gather additional information about the environment surrounding autonomous distribution vehicle 20.

Remote transceiver 23 includes a transmitter and receiver that is configured to communicate data with other transceivers. For example, remote transceiver 23 might be capable of communicating with central transceiver 14 that is located on first distribution vehicle 10. In another example, remote transceiver 23 might be capable of communicating with other transceivers, such as a transceiver located at starting location 2. Remote transceiver 23 may be configured to operate on a variety of frequencies such as Very High Frequency or Ultra High Frequency ranges. Furthermore, remote transceiver 23 might be compatible with specific network standards such as cell phone data networks, WIFI™, or BLUETOOTH® for sending and receiving data. Remote transceiver 23 might combine more than one of these capabilities to send and receive data. In a preferred embodiment, remote transceiver 23 will be capable of long range data communication, on the order of a mile or more in an urban environment, with multiple other transceivers. This embodiment of remote transceiver 23 will be capable of sending out a data stream containing an updated location determined by remote navigation sensor 22 at least once every 10 minutes and more preferably more than once every minute.

Controller 24 is configured to control all aspects of the operation of autonomous distribution vehicle 20. This includes guiding autonomous distribution vehicle 20 out of docking bay 16 and navigating to second volume customer location 36. Controller 24 is adapted to receive information from remote navigation sensor 22 and interpret that information to safely navigate through the environment. Controller 24 may also send and receive information through remote transceiver 23. Controller 24 may be any appropriate microprocessor or other controlling device known in the art.

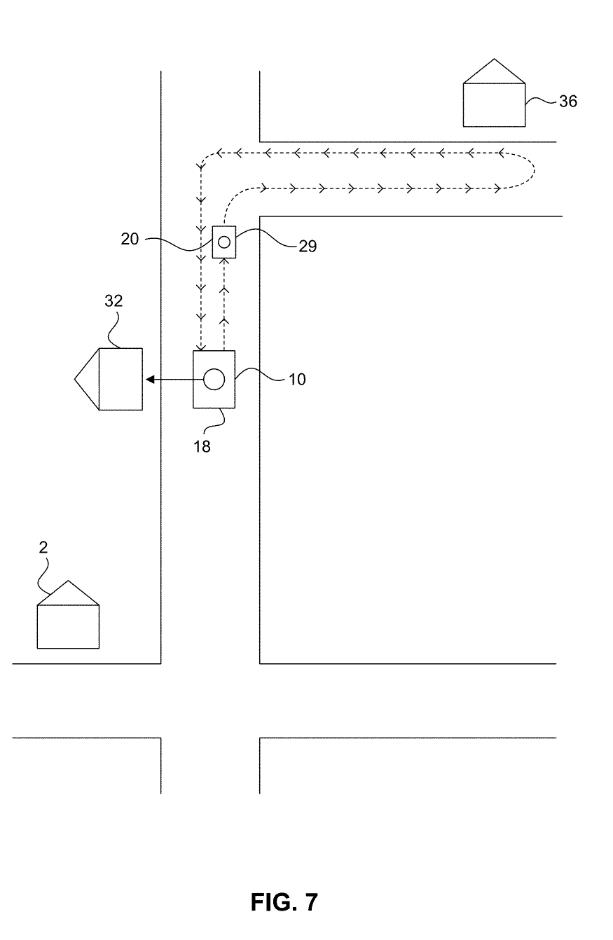

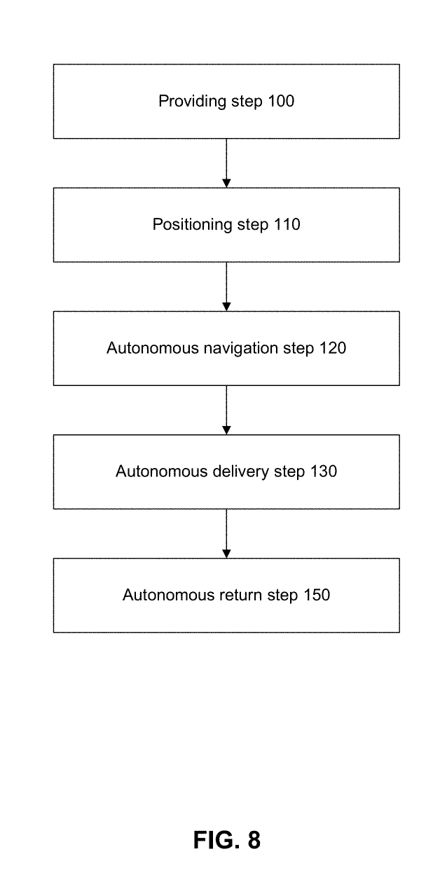

Autonomous distribution vehicle 20 includes at least one small cargo compartment 26 configured to store second set of food products 29. Small cargo compartment 26 is configured to be accessible from the exterior of remote autonomous vehicle 20. As seen in FIGS. 7 and 8, some embodiments of remote autonomous vehicle 20 might include six small cargo compartments 26. In this embodiment, the lids of small cargo compartments 26 are hinged near the centerline of autonomous distribution vehicle 20. When opened the lids swing up until they are approximately vertical and located near the centerline of autonomous distribution vehicle 20. Small cargo compartment 26 might also include small cargo compartment lock 27. This allows small cargo compartment 26 to be securely locked. An embodiment of small cargo compartment lock 27 might be a standard key-activated mechanical lock. In another embodiment, small cargo compartment lock 27 might be an electrical lock that can be controlled by controller 24. In this embodiment controller 24 can unlock the appropriate small cargo compartment lock 27, and corresponding small cargo compartment 26, upon receiving the appropriate input. This input might be a signal received by remote transceiver 23.

In some embodiments, controller 24 is configured to send out a signal that alerts second volume customer 34 when autonomous distribution vehicle 20 has reached second volume customer location 36. Second volume customer 34 might receive this alert as a phone call, text message, email, or alert from an application on a smart device. When second volume customer 34 acknowledges the alert, controller 24 might receive a message through remote transceiver 23 that instructs controller 24 to unlock the correct small cargo compartment 26. In another embodiment, second volume customer 34 might be able to command controller 24 to unlock small cargo compartment 26 using a command through an application on a smart device. A further embodiment might include a radio-frequency identification transmitter, NFC or BLUETOOTH® transmitter that interfaces with remote transceiver 23 when second volume customer 34 is near autonomous distribution vehicle 20. Upon receiving this information from remote transceiver 23, controller 24 will unlock the correct small cargo compartment 26.

Any of the embodiments of small cargo compartment 26 and small cargo compartment lock 27 have the effect of allowing autonomous distribution vehicle 20 to safely and securely carry multiple second sets of food products 29 and restrict the access of each second volume customer 34 to cargo compartment 26 that contains second set of food products 29 that is associated with that second volume customer 26. Including small cargo compartment lock 27 also helps prevent unauthorized access to small cargo compartment 26 during transit.

An embodiment of small cargo compartment 26 is sealed from the effects of the outside environment, such as heat, cold, rain, or dirt and debris. A further embodiment of small cargo compartment 26 includes an environmental control system 28 which can maintain a set temperature inside small cargo compartment 26. Environmental control system 28 might include heaters, coolers, or a combination of both as appropriate given the external environment and desired temperature range of small cargo compartment 26. In this embodiment, small cargo compartment 26 might include additional insulation, particularly if small cargo compartment 26 is often set to maintain a below-freezing temperatures. In some embodiments, small cargo compartment 26 may be configured to receive unwanted food products from a customer. For example, second volume customer 34 may retrieve their second set of food products 29 from small cargo compartment 26 and then place unwanted food products into small cargo compartment 26. The unwanted food products may then be returned to a central location for further use, such as recycling or composting.

In some embodiments, first distribution vehicle 10 might include more than one first set of food products 19 for delivery to multiple first volume customers 30. In this situation, it is possible that one or more autonomous distribution vehicles 20 might depart first distribution vehicle 10 while first distribution vehicle 10 is unloading at one of first volume customer locations 32, but not be finished with deliveries until first distribution vehicle 10 is at a different first volume customer location 32. In this embodiment, autonomous distribution vehicle 20 will be capable of navigating to the updated location of first distribution vehicle 10 received from central transceiver 23 of first distribution vehicle 10.

A method of using an embodiment of the disclosure is as follows. In a providing step 100, first distribution vehicle 10 is provided with at least one first set of food products 19. One or more autonomous distribution vehicles 20 are each provided with at least one second set of food products 29. In a positioning step 110, first distribution vehicle 10, with any autonomous distribution vehicles 20 onboard, moves to first volume customer location 32 and begins delivering first set of food products 19. While first distribution vehicle 10 is being unloaded, in an autonomous navigation step 120, any autonomous distribution vehicles 20 onboard first distribution vehicle 10 deploy and navigate to their respective second volume customer locations 36. In an autonomous delivery step 130, autonomous distribution vehicles 20 have reached their respective second volume customers 34 and deliver second set of food products 29. Some embodiments of autonomous distribution vehicle 20 may send an alert to second volume customer 34 when they reach second volume customer location 34 during autonomous delivery step 130. Autonomous navigation step 120 and autonomous delivery step 130 may be repeated as many times as necessary by each autonomous delivery vehicle 20 to ensure delivery of all second sets of food products 29.

During autonomous navigation step 120 and autonomous delivery step 130, first distribution vehicle 10 continues to deliver first set of food products 19. If first distribution vehicle 10 has been loaded with more than one first set of food products 19, positioning step 110 may be repeated as necessary to ensure delivery of all first sets of food products 19.

After each autonomous distribution vehicle 20 has finished delivering its final second set of food products 29, it returns to first distribution vehicle 10 in autonomous return step 140. If first distribution vehicle 10 has changed locations, autonomous distribution vehicle 20 may receive an updated location from central transceiver 23 of first distribution vehicle 10 and navigate to that location to rendezvous with first distribution vehicle 10. Autonomous return step 140 may also include the reloading of autonomous distribution vehicle 20 into first distribution vehicle 10.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A method for distributing food products to customers with a first distribution vehicle and an autonomous distribution vehicle disposed in the first distribution vehicle, comprising:
providing the first distribution vehicle with a first set of food products and providing the autonomous distribution vehicle with a second set of food products, wherein the first set of food products is associated with a first volume customer and the second set of food products is associated with a second volume customer, wherein the first volume is greater than the second volume;
positioning the first distribution vehicle at a location of the first volume customer and delivering the first set of food products;
directing the autonomous distribution vehicle to a location of the second volume customer during the delivering of the first set of food products, wherein the autonomous distribution vehicle further comprises a navigation sensor which is used to navigate the second distribution vehicle to the location of the second volume customer;
delivering the second set of food products to the second volume customer; and
returning the autonomous distribution vehicle to the first distribution vehicle using the navigation sensor.

2. The method of claim 1 further comprising:
providing the autonomous distribution vehicle with an additional second set of food products associated with an additional second volume customer; and
directing the autonomous distribution vehicle to a location of the additional second volume customer using the navigation sensors after delivering the second set of food products to the second volume customer; and
delivering the additional second set of food products to the additional second volume customer.

3. The method of claim 1 wherein the autonomous distribution vehicle is controlled by a remote operator who communicates with the autonomous distribution vehicle through a transceiver disposed in the autonomous distribution vehicle.

4. The method of claim 1 wherein the autonomous distribution vehicle is guided to the location of the second volume customer by a controller disposed in the second distribution vehicle and configured to receive input from the navigation sensor.

5. The method of claim 1 wherein the navigation sensor comprises a global positioning system sensor.

6. The method of claim 1 further comprising alerting the second volume customer that the second set of food products is ready to be delivered after the autonomous distribution vehicle arrives at the location of the second volume customer.

7. The method of claim 2, wherein the autonomous distribution vehicle further comprises a plurality of cargo compartments, each cargo compartment of the plurality of cargo compartments comprising a lock and being configured to securely and separately contain a set of food products, further comprising:
containing the second set of food products in a first cargo compartment of the plurality of cargo compartments in a locked configuration;
containing the additional second set of food products in a second cargo compartment of the plurality of cargo compartments in a locked configuration;
permitting unlocking of the first cargo compartment after the autonomous distribution vehicle reaches the second volume customer in order to allow for delivery of the second set of food products; and
permitting unlocking of the second cargo compartment after the autonomous distribution vehicle reaches the additional second volume customer in order to allow for delivery of the additional second set of food products.

8. The method of claim 1 wherein the first distribution vehicle further comprises a central navigation sensor and a central transceiver, further comprising:
communicating a current position of the first distribution vehicle in a continuous manner to the autonomous distribution vehicle; and
directing the autonomous distribution vehicle to return to the current position of the first distribution vehicle after delivering the second set of food products.

9. The method of claim 8 wherein the first distribution vehicle is provided with an additional first set of food products associated with an additional first volume customer, further comprising:
positioning the first distribution vehicle at a location of the additional first volume customer after delivering the first set of food products and delivering the additional first set of food products to the additional first volume customer.

10. The method of claim 1, wherein there are a plurality of autonomous distribution vehicles, each autonomous distribution vehicles of the plurality of autonomous distribution vehicles comprising a navigation sensor and being disposed in the first distribution vehicle, further comprising:
providing each of the plurality of autonomous distribution vehicles with a second set of food products associated with an additional second volume customer after loading the first distribution vehicle;
directing each of the plurality of autonomous distribution vehicles to a location associated with each of the additional second volume customers during delivery of the first set of food products;
delivering each of the additional second sets of food products to each of the additional second volume customers; and
directing each of the plurality of autonomous distribution vehicles to a location of the first distribution vehicle.

11. A system for delivering food products to customers using a plurality of vehicles, comprising:
a plurality of autonomous distribution vehicles; and
a non-autonomous distribution vehicle comprising a first cargo compartment configured to hold at least one first set of food products, and a second cargo compartment configured to store the plurality of autonomous distribution vehicles,
wherein each of the plurality of autonomous distribution vehicles comprises:
a remote navigation sensor, and
a small cargo compartment configured to hold at least one second set of food products,
wherein each of the plurality of autonomous distribution vehicles is configured to deliver the second set of food products autonomously to a location of the second volume customer while the non-autonomous distribution vehicle is delivering the first set of food products to the first volume customer and is further configured to autonomously return to the non-autonomous distribution vehicle after delivering the second set of food products.

12. The system of claim 11, further comprising:
a central transceiver disposed in the first distribution vehicle;
a central navigation sensor disposed in the second distribution vehicle;
a controller disposed in the autonomous distribution vehicle; and
a remote transceiver disposed in the autonomous distribution vehicle, wherein the central transceiver may communicate a current location of the first distribution vehicle obtained from the central navigation sensor to the autonomous distribution vehicle using the remote transceiver, and wherein the controller may direct the autonomous distribution vehicle to the current location of the first distribution vehicle.

13. The system of claim 11 wherein the central navigation sensor comprises a global positioning system sensor and the remote navigation sensor comprises a global positioning system sensor.

14. The system of claim 12 wherein the controller is configured to send an alert to the second volume customer using the remote transceiver when the autonomous distribution vehicle has arrived at the location of the second volume customer.

15. The system of claim 11 wherein the autonomous distribution vehicle further comprises a plurality of small cargo compartments, wherein each of the plurality of small cargo compartments comprises a lock and is configured to securely and separately contain at least one set of food products.

16. The system of claim 15 wherein the lock may be unlocked by the controller upon receiving an unlock signal.

17. The system of claim 12 wherein the autonomous distribution vehicle is configured to be controlled by a remote operator through the remote transceiver.

18. The system of claim 12 wherein the second cargo compartment further comprises a plurality of docking bays, each of the plurality of docking bays being configured to securely and releasably carry the autonomous distribution vehicle, wherein each of the plurality of docking bays comprises a docking bay interface that is configured to transmit electrical power and data signals between the first distribution vehicle and the autonomous distribution vehicle.

19. The system of claim 15 wherein each of the plurality of small cargo compartments further comprises an environmental control system configured to maintain a selected temperature in the small cargo compartment.

20. The system of claim 11, wherein each of the plurality of autonomous distribution vehicles is releasably disposed in the non-autonomous distribution vehicle.
